(19) United States
(12) Patent Application Publication
(10) Pub. No.: US 2025/0263887 A1
(43) Pub. Date: Aug. 21, 2025

(54) COMPOSITE MATERIAL COMPRISING POLYURETHANE AND TANNED BACTERIAL CELLULOSE, AND METHOD FOR MANUFACTURING THE SAME

(71) Applicant: Polybion, S.L., Madrid (ES)

(72) Inventors: Alexis Manuel Gómez-Ortigoza Aguirre, Guanajuato (MX); Axel Alejandro Gómez-Ortigoza Aguirre, Guanajuato (MX)

(73) Assignee: Polybion, S.L., Madrid (ES)

(21) Appl. No.: 18/858,481

(22) PCT Filed: May 12, 2022
(86) PCT No.: PCT/IB2022/054414

§ 371 Date: Oct. 21, 2024

(51) Int. Cl. D06N 3/00; B32B 5/18; B32B 5/20; B32B 23/04; C08J 5/12; C08J 7/04; C09D 175/04; C09J 5/00; C09J 175/04; D06N 3/14

(52) U.S. Cl. CPC D06N 3/0043; B32B 5/18; B32B 5/20; B32B 23/04; C08J 5/127; C08J 7/0427; C09D 175/04; C09J 5/00; C09J 175/04; D06N 3/0015; D06N 3/0045; D06N 3/0088; D06N 3/146; B32B 2255/26; B32B 2266/0278; B32B 2307/54; B32B 2307/724; B32B 2307/7376; C08J 2301/02; C08J 2375/04; C08J 2475/04; C09J 2400/246; C09J 2401/008; C09J 2475/00

(57) ABSTRACT

The present invention refers to a composite material comprising a polyurethane foam backing material sheet and a tanned bacterial cellulose (BC) membrane either integrally joint together or adhered to each other by an adhesive, and methods for manufacturing the same.

### FIELD OF THE INVENTION

The invention pertains to the field of materials technology, specifically to composite materials comprising a biomaterial and, more specifically the invention refers to a composite material comprising a polyurethane foam backing material sheet and a tanned bacterial cellulose (BC) and methods for manufacturing the same. The composite material of the present invention is useful, for example, in industries associated with leather such as the textile, clothing, apparel, footwear, furniture and transport sectors.

### BACKGROUND OF THE INVENTION

Leather has been around since the time humans have needed clothes for cover and for warmth. Animal skins have been used to satisfy the basic needs of clothing, shelter and floor covering. Turning a hide into a functional material requires stopping the decay of and softening the leather for workability.

Numerous ways are known to prepare a skin or hide and convert it to leather, including salting or refrigerating a hide or skin to preserve it; soaking it in an aqueous chemical solution to remove salt, dirt, debris, blood, and excess fat, and finally tanning the leather to increase its durability.

Nevertheless, raising animals for food and leather requires huge amounts of feed, pastureland, water, and fossil fuels. Besides, the production of leather hurts animals and the environment. Therefore, there is the need of producing synthetic leathers that mimic the properties of natural leather avoiding both cruelty to animals and environmental damage.

Cellulose is the most abundant, inexpensive and readily available carbohydrate in the world, traditionally extracted from plants or their wastes. Although plants are the major contributor of cellulose, various bacteria are able to produce cellulose as an alternative source. (Overview of Bacterial Cellulose Production and Application, Faezah et al. 2014, page 113). Thus, bacterial cellulose (BC) is considered a potential leather substitute, since this type of cellulose can be generated at desired thicknesses and, when dried, produce a resilient leather-like material with properties that resemble the type of animal leather used for example in the footwear industry.

Polymeric foams are materials with high importance in the field of composite materials. Conventional foams are produced from oil-based polymers such as foamed polyvinyl chloride (PVC), polyethylene (PE), polyurethane (PU), polystyrene (PS), polymethacrylimide (PMI) and polypropylene (PP).

WO 2012/032514 A1 discloses composite materials comprising cellulose and polymeric materials, wherein the cellulose material is a cellulose nano-material scaffold which can be selected from a group comprising bacterial cellulose, bounded to a polymer resin being a thermoplastic polyurethane. According to this patent document, a scaffold is a structure characterized by open cellular structures containing pores connected to one another forming an interconnecting network. Such scaffold is produced by trapping water in pore domains within the solid cellulose nano-material and subsequently removing the water using a freeze-solvent exchange process. However, in order to achieve the desired foamed structure, the synthetic leather must undergo an additional process.

WO 2021/128272 A1 discloses a bacterial-cellulose polyurethane composite material, wherein the bacterial cellulose substrate is formed by two compounds of bacterial cellulose microfibers of different concentrations, namely compound A and compound B, wherein composite A is a mixture of bacterial cellulose microfibers and organic solvents after being complete dehydrated, and composite B is a mixture of bacterial cellulose microfibers with free surface water removed and still containing a small amount of bound water and organic solvent. Nonetheless, since the purpose of this document is to provide a bacterial cellulose-polyurethane composite material with a gradient structure for human body repair materials, intelligent drug slow-release materials and tissue engineering materials, the used bacterial cellulose is not tanned, making such composite material not suitable for being used in industries associated with leather such as the textile, clothing, apparel, footwear, furniture and transport sectors.

EP 3 715 110 A1 discloses a composite material used as a leather alternative material comprising a layer of bacterial cellulose (BC) attached to a layer of biobased and biodegradable plastic selected from the group consisting of polyesters and polysaccharides or copolymers thereof. This document is silent about using a polyurethane foam backing material sheet.

### SUMMARY OF THE INVENTION

The object of the present invention is to provide a composite material with improved mechanical properties which confer a soft, malleable, and cushioned backing alternative to leather.

The composite material according to the present invention comprises:
a polyurethane foam backing material sheet; and
a tanned bacterial cellulose membrane.

The invention also relates to methods to manufacture the above-mentioned composite material. In an embodiment, a PU injection method is provided comprising the following steps:
placing a tanned bacterial cellulose membrane into a mold,
mixing and injecting polyol and diisocyanate into said mold to integrally form a polyurethane foam backing material sheet over said tanned bacterial cellulose membrane.

In an alternative embodiment, the composite material of the present invention can be manufactured through a lamination method comprising the following steps:
providing a polyurethane foam backing material sheet, an adhesive and a tanned bacterial cellulose membrane so that the adhesive is sandwiched between the polyurethane foam backing material sheet and the tanned bacterial cellulose membrane; and
performing a lamination process to adhere the polyurethane foam backing material sheet to the tanned bacterial cellulose membrane.

The term “tanned” in the context of the present invention refers to a process used to avoid rotting applied to a bacterial cellulose membrane through which the resistance, flexibility and performance of the bacterial cellulose, are improved.

### BRIEF DESCRIPTION OF THE DRAWINGS

FIG. 1 illustrates a perspective cross-sectional view of a composite material according to a preferred embodiment of the present invention.

FIG. 2 illustrates a flow chart of the PU injection method for manufacturing a composite material according to a preferred embodiment of the present invention.

FIG. 3 illustrates a flow chart of a lamination method for manufacturing a composite material according to a preferred embodiment of the present invention.

### DETAILED DESCRIPTION OF THE INVENTION

A composite material is a combination of two materials with different physical and chemical properties, creating a material with improved, specialized features for certain applications.

Cellulose is traditionally extracted from plants or their wastes. Although plant is the major contributor to cellulose, various bacteria are able to produce cellulose as an alternative source.

Due to bacterial cellulose (BC) structure consists only of glucose monomer, it exhibits numerous great properties such as unique nanostructure, high water holding capacity, high degree of polymerization, high mechanical strength and high crystallinity. (Overview of Bacterial Cellulose Production and Application, Faezah et al. 2014, page 114).

Thus, it is widely accepted that BC has distinctive and superior properties compared to vegetal cellulose, in terms of purity, resistance, malleability, water retention; making this material a good candidate for applications in fields such as biotechnology, microbiology, and material science. When tanned, BC exhibits leather like properties and performance.

Polyurethane is a versatile material that appears in a large amount of everyday household items and machinery. It has several advantages over other synthetic materials. It is so flexible that is often used in products that are designed for human comfort and relaxation. Some of the most common applications of polyurethane include furniture, bedding and seating (flexible PU foams), thermal insulation (rigid PU foams), elastomers, footwear and coatings.

Flexible polyurethane (PU) foam is used as cushioning for a variety of consumer and commercial products, including bedding, furniture, automotive interiors, carpet underlay and packaging. Flexible foam can be created in almost any variety of shapes and firmness. It is light, durable, supportive and comfortable. Thus, given the advantages obtained by using flexible PU foams, products such as PU leather are increasingly used. PU leather is a polymer substance similar to leather made of PU having the same aspect and touch than natural leather. The most common way of forming PU leather is applying a polyurethane coating over a fibrous base, generally polyester.

In an embodiment, the present invention discloses a new composite material with improved mechanical properties to be used as a leather alternative material.

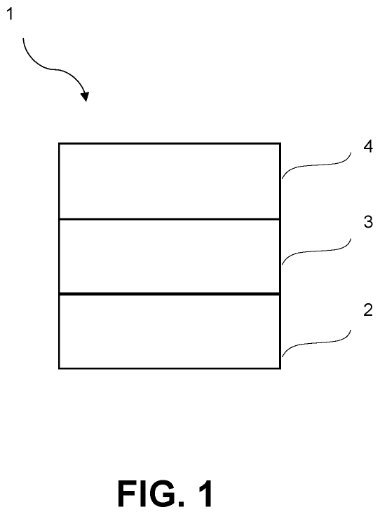

FIG. 1 illustrates a perspective cross-sectional view of a composite material (1) according to a preferred embodiment of the present invention, wherein the composite material (1) comprises:
a polyurethane foam backing material sheet (2); and
a tanned bacterial cellulose membrane (3).

Optionally, the composite material (1) comprises a coating material (4).

The tanned bacterial cellulose membrane (3) of the composite material (1) is a biopolymer (polysaccharide) obtained from metabolic processes of prokaryotic cells by using a suitable substrate. The bacterial cellulose membrane material can be any biopolymer synthesized by fermentation of prokaryotes including polysaccharides (composed of sugars and/or sugar acids connected by glycosidic linkages), peptides and proteins (composed of amino acids connected by peptide bonds).

According to the present invention, the BC may be obtained by any procedure known in the state of the art. In an exemplary embodiment, a polysaccharide (also known as bio nanocellulose, bacterial cellulose, nanocellulose, etc.) is used due to its unique properties such as: high biodegradability, biocompatibility, high crystallinity, a fine fiber network, and high tensile strength in the wet state (which enables tanning without rupture). The selection of the bacterial strain will influence the fermentation rate.

In this exemplary and not limitative embodiment, a bacterial culture can be selected from any of the following group: Komagataeibacter sp, Gluconacetobacter sp, Acetobacter sp, Rhizobium sp, Sarcina sp, Pseudomonas sp, Achromobacter sp, Alcaligenes sp, Aerobacter sp, and Azotobacter sp; said bacteria culture is incubated in a growth medium based on, for example, fruit wastes such those derived from as pineapple, mango, strawberry, guava, apple and grape. Those skilled in the art will understand that while wastes are preferable due to environmental reasons, the mentioned fruits themselves can be used for the purpose of this invention. The methods for obtaining the BC include static, agitated/shaking, and bioreactor cultures (which have an agitation system also). Those skilled in the art would infer that a plurality of wastes or organic materials can be used as a substrate for bacterial growth as well as different suitable bacteria can be selected for the purposes of the current invention. An example of the method for obtaining the tanned bacterial cellulose membrane (3) according to the present invention is shown below:

The BC growing process according to the present invention consists of using industrial food waste as a circular carbon source to feed the BC-producing microorganisms. The growth process can be carried out in trays, vertically stacked on racks, optimizing footprint trough a vertical production system. The vertical production system is housed in a controlled environment, a room-sized incubator with IoT sensors and actuators to monitor and control in real time parameters such as: Temperature (° C.), CO₂ (ppm), Air Flow (cfm), Humidity (%), light (lux), among others. This allows for process and quality control capabilities, ensuring replicability, scalability and continuous optimization.

The process starts by processing the food waste, in order to reduce water activity (Wa), allowing thereby the preservation at room temperature for over 12 months without decomposition or productivity loss. The food waste is dried to reduce its water content below 60%, which is achieved by placing the food waste in a dehydration chamber for several hours until the Wa value is <0.8. A solar dehydration chamber might be used as-well. Then the food waste can be stored in standard 1,000 L polypropylene (PP) hermetic containers or intermediate bulk containers containers, at room temperature (25° C.).

The next step of the process is to prepare the growth liquor by formulating a growth medium with the composition defined in Table 1:

TABLE 1
Growth liquor composition

| Component | Concentration (w/v) |
|---|---|
| Carbon source | 10% |
| Dried Black Tea | 2% |
| Water | As solvent |

Once the growth liquor is prepared, it is sterilized using an autoclave. The sterile growth liquor is then inoculated with the BC-producing microorganism, such as Acetobacter xylinum. In order to maintain an exponential growth curve, only BC-producing microorganisms go into the fresh growth liquor, thus promoting a healthy culture that produces good quality BC. Once the liquor is inoculated, it is then placed into the growth system of trays. When the rack is completely full of trays, it is then transported into a room-sized incubator, using a railing system to facilitate movement of the rack. Now the growth process begins, under controlled conditions. After some days the raw BC is ready to be collected.

The obtained BC is washed, and PH neutralized in order to prepare it for the subsequent tanning process. The BC is subjected to a tanning process carried out in a tanning system, wherein the tanning method can be selected from chrome tanning, vegetal tanning and mineral tanning, wherein any commercial tanning solution composition can be used in the tanning process; the BC is drained, and a tanned bacterial cellulose membrane (3) is thus obtained.

On the other hand, according to an embodiment of the present invention the polyurethane foam backing material sheet (2) obtained by a polymerization chemical reaction comprising mixing diisocyanate with a polyol to produce a foaming reaction. The polyol in the foaming reaction might be algae-oil-derived (producing Bio-PU) or petroleum-derived (producing conventional PU) indistinctively. The difference between BioPU and PU is the source of the polyol in the foaming reaction. In the conventional PU, polyol is derived from petroleum that is refined to obtain polyol. In BioPU, polyol is derived from algae oil, which is extracted from microalgae, grown in conventional algae farms and extracted using purification procedures. Since petroleum (oil) is actually, mostly fossilized algae oil, the source of the polyol does not affect the aspect nor performance of the resulting PU foam, but it does affect biodegradability. BioPU is biodegradable due to the nature of its polyol monomers. Algae-oil-derived polyol monomers have an extra methyl group and thus, form a slightly different covalent bond when polymerized compared to conventional oil-derived-polyol, which can be broken by enzymes in soil and marine microorganisms, and thus is biodegradable in such environments.

The obtained PU according to the present invention is a flexible PU obtained from omega-3 depleted algae biomass through the preparation of polyester polyols. The obtention process requires five stages:
purification of fatty acids from omega-3 depleted algae oil; isolation of palmitoleic acid (C16:1) from free fatty acids; synthesis of azelaic acid (AA, C9-dicarboxylic acid) from C16:1; polycondensation of ethylene glycol and AA for polyester polyol synthesis; and polymerization with methylenediphenyl diisocyanate (MDI).

Mechanical properties of BioPU strongly depend on the degree of crosslinking and network structure of the PU foam. The diisocyanate react with algae polyol leads to urethane linkage which generates the hard domain of PU foam because of the possibility of association by hydrogen bond while the high molecular weight and mobility of algae polyol represent the soft domain, resulting in superior mechanical properties.

The hysteresis and peak force values trend well with shore hardness, and the more rigid algae PU cubes demonstrate lower energy loss and higher peak force as is expected. The properties of algae-based PU cubes are shown in Table 2 below:

TABLE 2
Azelaic Polyol Foam Cube Properties

| | | | Avg. | |
|---|---|---|---|---|
| | Avg. Density | Avg. Hardness | Hysteresis | Avg. Peak |
| Formula | (kg/m³) | (Shore A) | (%) | Force (N) |
| Photosynthetic | 297 ± 4 | 30 ± 3 | 51 ± 3 | 217 ± 17 |
| PU foam | | | | |

In the composite material (1) the polyurethane foam backing material sheet (2) and the tanned bacterial cellulose membrane (3) are either integrally joint together or adhered to each other by an adhesive.

The composite material (1) additionally may optionally comprise a coating material (4) applied over the surface of the tanned bacterial cellulose membrane (3). The coating material (4) is selected from a material comprising any of polyurethane, silicone, acrylic, protein-based, plant-resin and wax.

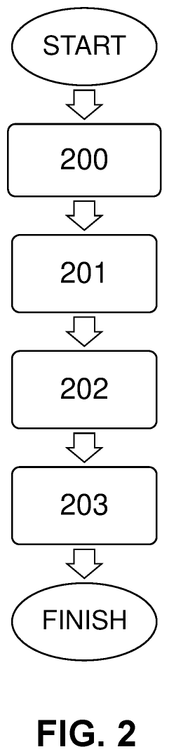

FIG. 2 is a flow chart of a PU injection method whereby the PU foam backing material sheet (2) and the tanned bacterial cellulose membrane (3) are integrally joint together. The PU injection method can be performed in a PU injection machine and mold. Step 200 comprises placing a tanned bacterial cellulose membrane (3) in a corresponding surface of a selected mold; step 201 comprises agitating two different reactants, namely polyol and diisocyanate in separated tanks, such reactants are kept at a stable temperature between about 50° C. and about 80° C., the diisocyanate to polyol ratio is preferably between 10:100 and 80:90; in step 202, a pump moves each reactant through separate hoses to an injection nozzle where the reactants get mixed and injected at the same time to the tanned bacterial cellulose membrane (3) within the mold, which causes that the reaction catalyzes simply by mixing, the flow of the reactants in the nozzle can be around from about 30 to about 50 g/s; step 203 comprises closing and clamping the mold in order to prevent the pressure of the reaction moving the mold parts so the right shape of the piece is maintained. The reaction time is in the range between 1 and 60 min.

By performing this method, a double operation is achieved, where PU/BioPU foam polymerization occurs at the same time that the produced foam gets permanently adhered to the tanned bacterial cellulose membrane (3) by means of the PU reaction, forming thereby the composite material (1).

Parameters such as temperature, reactants ratio, reaction time and flow can be advantageously selected depending on the piece to be manufactured. Furthermore, such parameters can be set in the PU injection machine controls.

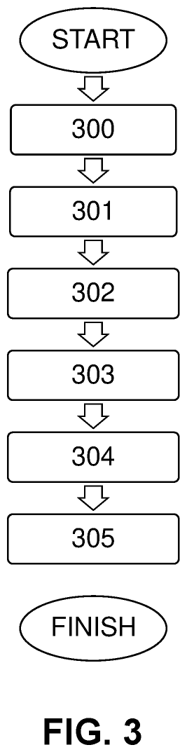

FIG. 3 is a flow chart of a lamination method whereby the PU foam backing material sheet (2) and the tanned bacterial cellulose membrane (3) are adhered to each other by an adhesive. The PU foam backing material sheet (2) can be manufactured in a PU injection machine comprising a mold. The lamination process can be performed in a lamination machine. Step 300 comprises selecting a mold to receive a mixture of reactants; step 301 comprises agitating two different reactants, namely polyol and diisocyanate in separated tanks, such reactants are kept at a stable temperature between about 50° C. and 80° C. and the diisocyanate to polyol ratio is preferably from 10:100 to 80:90; in step 302 a pump moves each reactant through separate hoses to an injection nozzle where the reactants get mixed and injected at the same time to the selected mold, which causes the reaction to catalyze simply by mixing. The flow of the reactants in the nozzle can be from about 30 to about 50 g/s. The reaction time is in the range between 1 and 60 min.

Parameters such as temperature, reactants ratio and flow can be advantageously selected depending on the piece to be manufactured. Furthermore, such parameters can be set in the standard PU injection machine controls.

Once the PU foam (2) has been polymerized in the desired shape, in step 303 an adhesive layer is provided onto the PU foam (2). The adhesive is a material selected from a water based polyurethane adhesive, a copolyimide, a copolyester, Ethylene-Vinyl Acetate, PVC adhesive, silicone, etc. The amount of adhesive to be used depends on the composite material surface area, an adhesive film between 10 and 100 microns is desired, around 0.1 g of adhesive per cm² of composite material (1) used.

After providing the adhesive layer onto the PU backing material sheet (2), in step 304 the adhesive is sandwiched between said PU foam backing material sheet (2) and a tanned bacterial cellulose membrane (3).

Step 305 comprises performing a lamination process to adhere the polyurethane foam backing material sheet (2) to the tanned bacterial cellulose membrane (3), forming thereby the composite material (1). The lamination process is preferably carried out at a rate between about 0.1 and about 10 m/min and a temperature between about 60 and about 250° C. However, these parameters could be selected depending on the melting point of the adhesive used.

Both manufacturing methods may comprise an additional step of applying a coating material (4) over the surface of the tanned bacterial cellulose membrane (3). The coating material (4) is selected from a material comprising any of polyurethane, silicone, acrylic, protein-based, plant-resin and wax.

The coating may be sprayed on the BC membrane (3) using standard tools for leather top coating operations, such as a pneumatic spray gun.

The composite material (1) is conformed as a layered material. In a preferred embodiment the composite material (1) comprises a polyurethane foam backing material sheet (2) layer having preferably a width of about 0.2 to 10 mm; a tanned bacterial cellulose membrane (3) layer having preferably a width of about 0.2 to 2.5 mm; and a coating material (4) layer having preferably a width between 5 and 100 microns.

### EXAMPLES

In a not limitative example of the present invention, the PU injection method was performed in a standard PU injection machine with a mold cavity of 210 mm by 297 mm, and 1.6 mm deep. A tanned bacterial cellulose membrane of 0.6 mm thick, was placed inside the selected mold. The polyol and diisocyanate were agitated in separated tanks at a stable temperature of 60° C. The reactants were injected into the mold at a flow in the nozzle of 40 g/s in a diisocyanate to polyol ratio of 30:100; the mold was closed and clamped during 10 min. The obtained composite material was demolded and a coating composed of polyurethane was sprayed on the BC membrane side of the composite, using a standard pneumatic spray gun of 30 micrometers thick. The polyurethane foam backing material sheet is of 1 mm thick and the final composite material is of 1.6 mm thick.

In another not limitative example of the present invention, a lamination method was performed in a lamination machine. A PU sheet was obtained by injecting diisocyanate and polyol at a stable temperature of 60° C. in a diisocyanate to polyol ratio of 30:100, and a flow of the reactants in the nozzle of 40 g/s. The polymerization reaction time was 10 min. Once the PU foam was polymerized in the sheet shape, the tanned bacterial cellulose membrane was laminated using water based polyurethane, with a 30-micron adhesive layer, at a rate of 1 m/min and a temperature of 90° C. A coating composed of polyurethane was sprayed on the BC membrane side of the composite, using a standard pneumatic spray gun of 30 micrometers thick. The polyurethane foam backing material sheet was 1 mm thick and the tanned bacterial cellulose membrane layer was 0.6 mm.

For comparison, the following table of the mechanical performance of both examples is shown:

| | Composite material | Composite material | | |
|---|---|---|---|---|
| | according to the | according to the | | |
| | present invention | present invention | Synthetic | |
| | obtained through | obtained through | plastic | Calf |
| Test | injection | lamination | leather | leather |
| Tensile strength | 18 | 16 | 4.8 | 19.6 |
| (Mpa) | | | | |
| Elongation (%) | 16 | 17 | 18 | 40 |
| Tear strength (N) | 23 | 22 | 25 | 49 |
| Thickness (mm) | 1.5 | 1.5 | 1 | 1.5 |
| Bally Flex (cycles) | >150,000 | >150,000 | >48,000 | >48,000 |
| Bally Flex Wet | 26,500 | 26,500 | >20,000 | >18,000 |
| (cycles) | | | | |
| Bally Flex Sweat | 18,000 | 18,000 | >15,000 | >18,000 |
| (cycles) | | | | |
| Water vapor | 3.3 | 3.3 | 2 | 4 |
| (mg/cm²*h) | | | | |

Some examples of the use of the present invention as a final product comprise seats and interior parts for the transportation sector for instance but not limited to automobiles, trains, airplanes and buses as well as for the footwear industry in the confection of shoes.

The present invention has been sufficiently disclosed throughout preferred embodiments thereof; however, it should be understood that variations and modifications can be carried out by a skilled in the art without implying that such variations and/or modifications depart from the gist of the present invention. Thus, such variations and/or modifications fall within the scope of the present invention according to the claims appended to the present specification.

1.-19 (canceled)

20. A method for manufacturing a composite material comprising the following steps:
subjecting a bacterial cellulose membrane to a tanning process, wherein the tanning process is selected from chrome tanning, vegetal tanning and mineral tanning;
draining the tanned bacterial cellulose membrane;
placing the tanned bacterial cellulose membrane into a mold; and
mixing and injecting a polyol and a diisocyanate into said mold to integrally form a polyurethane foam backing material over said tanned bacterial cellulose membrane.

21. The method according to claim 20, wherein the polyol in the foaming reaction is selected from algae-oil-derived polyol or petroleum-derived polyol.

22. The method according to claim 20, wherein the polyol and the diisocyanate are provided from two agitated tanks respectively, and each tank is kept at stable temperature between 50 and 80° C.

23. The method according to claim 20, wherein the diisocyanate to polyol ratio is from 10:100 to 80:90.

24. The method according to claim 20, further comprising:
applying a coating material over the surface of the tanned bacterial cellulose membrane.

25. The method according to claim 24, wherein the coating material is selected from a material comprising any of polyurethane, silicone, acrylic, protein-based, plant-resin and wax.

26. A method for manufacturing a composite material comprising the following steps:
subjecting a bacterial cellulose membrane, to a tanning process, wherein the tanning process is selected from chrome tanning, vegetal tanning, and mineral tanning;
draining the tanned bacterial cellulose membrane;
providing a polyurethane foam backing material sheet, an adhesive and the tanned bacterial cellulose membrane so that the adhesive is sandwiched between the polyurethane foam backing material sheet and the tanned bacterial cellulose membrane; and
performing a lamination process to adhere the polyurethane foam backing material sheet to the tanned bacterial cellulose membrane.

27. The method according to claim 26, wherein the adhesive is a material selected from a water based polyurethane adhesive, a copolyamide, a copolyester, and Ethylene-Vinyl Acetate, PVC adhesive and silicone.

28. The method according to claim 26, wherein the polyurethane in the polyurethane foam backing material sheet is selected from petroleum-derived polyurethane or bio-polyurethane.

29. The method according to claim 26, wherein the lamination process is carried out at a rate between 0.1 and 10 m/min and a temperature between 60 and 250° C.

30. The method according claim 26, further comprising:
applying a coating material over the surface of the bacterial cellulose membrane.

31. The method according to claim 30, wherein the coating material is selected from a material comprising any of polyurethane, silicone, acrylic, protein-based, plant-resin and wax.

32. A composite material comprising:
a) a polyurethane foam backing material sheet; and
b) a tanned bacterial cellulose membrane, wherein the bacterial cellulose membrane has been tanned by subjecting it to a tanning process selected from chrome tanning, vegetal tanning and mineral tanning.

33. The composite material according to claim 32, wherein the polyurethane foam backing material sheet and the tanned bacterial cellulose membrane are either integrally joint together or adhered to each other by an adhesive.

34. The composite material according to claim 33, wherein the adhesive is a material selected from a water based polyurethane adhesive, a copolyamide, a copolyester, Ethylene-Vinyl Acetate, PVC adhesive and silicone.

35. The composite material according to claim 32, wherein the polyurethane in the polyurethane foam backing material is selected from petroleum-derived polyurethane or bio-polyurethane.

36. The composite material according to claim 32, further comprising a coating material applied over the surface of the tanned bacterial cellulose membrane.

37. The composite material according to claim 36, wherein the coating material is selected from a material comprising any of polyurethane, silicone, acrylic, protein-based, plant-resin and wax.

38. The composite material according to claim 37, wherein the coating material is conformed as a layered material comprising a polyurethane foam backing material sheet having a thickness of 0.2 to 10 mm, a tanned bacterial cellulose membrane layer having a thickness of 0.2 to 2.5 mm, and a coating material layer having a thickness between 5 and 100 microns.
